(19) United States
(12) Patent Application Publication
(10) Pub. No.: US 2009/0148811 A1
(43) Pub. Date: Jun. 11, 2009

(54) Apparatus and Method of Irregular Bone Defect Detection of Dental Implant

(75) Inventors: Min-Chun Pan, Ping-Jen City (TW); Han-Bo Chuang, Dashu Township (TW); Shyh-Yuan Lee, Taipei City (TW)

Correspondence Address: TROXELL LAW OFFICE PLLC, 5205 LEESBURG PIKE, SUITE 1404, FALLS CHURCH, VA, 22041, US

(73) Assignee: National Central University, Taoyuan County (TW)

(21) Appl. No.: 12/329,569

(22) Filed: Dec. 6, 2008

(30) Foreign Application Priority Data
Dec. 6, 2007 (TW) 096146553

(51) Int. Cl. A61C 19/04

(52) U.S. Cl. 433/72

(57) ABSTRACT

The present invention detects an irregular bone defect of a dental implant. Resonance frequency is produced and received to recognize a quality, a direction and a depth of the irregular bone defect. Thus, an osseointegration is evaluated, and the present invention is of great help to dental diagnosis and osseointegration surgery.

### FIELD OF THE INVENTION

The present invention relates to bone defect detection; more particularly, relates to quantitatively evaluating an osseointegration between a dental implant and an alveolar bone through differences of dynamic characteristics of the dental implant and irregular bone defects and furthermore obtaining quality direction and depth of bone defect.

### DESCRIPTION OF THE RELATED ARTS

General devices for detecting implant stability or bone defect use non-destructive method with vibration. Among these methods, impulse force or sinusoidal wave is used to vibrate a dental implant to evaluate integrity between the dental implant and an alveolar bone through analyzing a resonance frequency.

A prior art is a U.S. Pat. No. 5,392,779 patent. The first prior art provides a method and apparatus for testing an implant attached to a human or animal bone, where the apparatus has a transducer for vibrating the implant; and a resonance frequency is detected to evaluate integrity of the attachment between the implant and the bone. Another prior art is a U.S. No. 2002/0143268A1 patent. The prior art comprises a device with a transducer; a connector connected with the device; and a memory device for storing detected data, where the device vibrates a bone implant through the transducer to obtain a stability of the bone implant through analyzing a resonance response of the vibration. And, another prior art is a U.S. Pat. No. 7,147,467 patent. The prior art provides a measurement instrument for obtaining a tooth mobility, comprising a device for hitting a tooth; a sensor for sensing a movement of a tooth; and a device for calculating the mobility of the tooth on the basis of an output signal from the sensor.

The above prior arts provides methods for detecting implant stability through vibration non-destructively, yet only overall integrity between a dental implant and an alveolar bone is obtained, but not quality, direction and depth of bone defect. Although an X-ray device can be used to obtain the quality, direction and depth of bone defect, detecting through the X-ray device is an invasive detection and 2-dimentional image thus obtained has a limit on diagnosis. Conclusively, these prior arts do not solve all problems on diagnosing osseointegration. Hence, the prior arts do not fulfill all users' requests on actual use.

### SUMMARY OF THE INVENTION

The main purpose of the present invention is to quantitatively obtain an osseointegration status between a dental implant and an alveolar bone and to detect a quality, a direction and a depth of a bone defect.

Another purpose of the present invention is to evaluate strength of the dental implant through analyzing the osseointegration status between the dental implant and the alveolar bone.

To achieve the above purpose, the present invention is an apparatus and method of an irregular bone defect detection of a dental implant. The apparatus comprises a metal attachment, a detecting probe, a transducer/detector driver unit and a detecting instrument. The apparatus has a method comprising steps of: (a) locking the metal attachment on a dental implant and connecting the detecting probe to the transducer/detector driver to be enfolded on the metal attachment; (b) connecting the transducer/detector driver unit to the detecting instrument through a cable line and connecting the detecting instrument to a personal computer through a USB cable while the personal computer is used to control operations of the detecting instrument and testee data are transferred to the personal computer to be managed (c) producing a sound wave by a sound-wave vibration producing device of the detecting instrument with a sound transducer of the detecting probe through the transducer/detector driver unit to vibrate the metal attachment, sensing and receiving a vibration signal through a micro accelerometer of the detecting probe, and transmitting the vibration signal to a structural-response receiver and frequency analyzer unit of the detecting instrument through the transducer/detector driver unit to be analyzed; and (d) transforming the analyzed vibration signal to a digital signal to be transmitted to a processor of the detecting instrument, figuring out values of resonance frequencies by the processor, displaying the calculated data on an LCD, and storing the calculated data in a memory. Accordingly, a novel apparatus and method of an irregular bone defect detection of a dental implant is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the structural view showing the preferred embodiment according to the present invention;

FIG. 2 is the view showing the status of use;

FIG. 3 is the view showing the detection flow; and
FIG. 4 to FIG. 7 are the views showing the first to the seventh preferred embodiment of the detecting probe.

### DESCRIPTION OF THE PREFERRED EMBODIMENT

The following description of the preferred embodiment is provided to understand the features and the structures of the present invention.

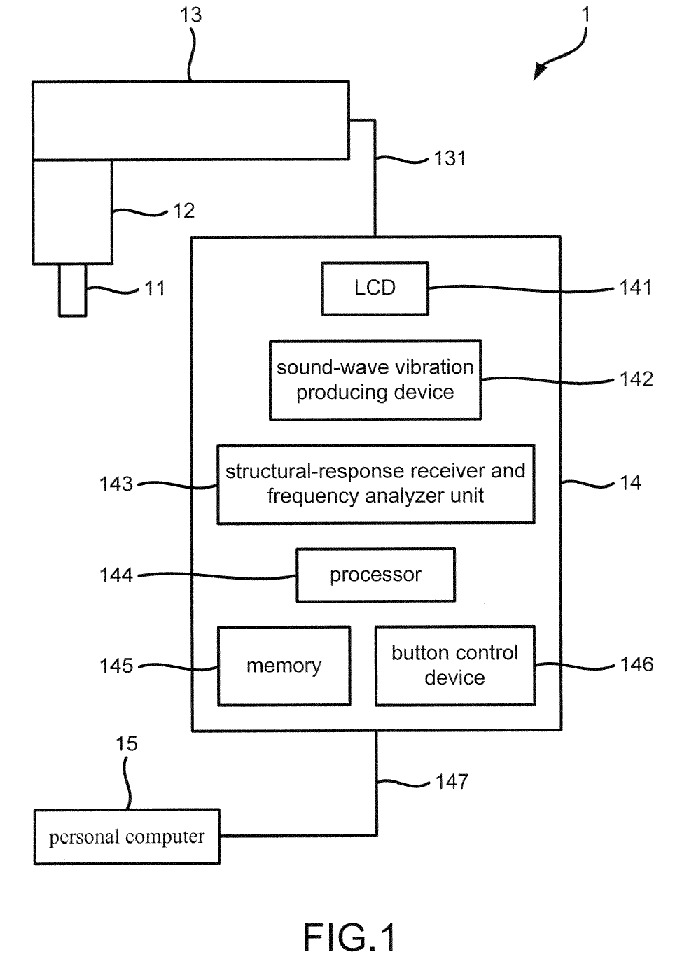

Please refer to FIG. 1, which is a structural view showing a preferred embodiment according to the present invention. As shown in the figure, the present invention is an apparatus and method of an irregular bone defect detection of a dental implant, where the apparatus 1 comprises a metal attachment 11, a detecting probe 12, a transducer/detector driver unit 13 and a detecting instrument 14.

The metal attachment 11 is made of an anticorrosive metal material with a pillar shape and has a thread at bottom to be locked on a dental implant, where a size of the metal attachment 11 is changeable according to the dental implant.

The detecting probe 12 comprises a sound transducer at a transmitting end and a micro accelerometer at a receiving end to be enfolded on the metal attachment 11 for outputting and receiving vibration signal, where the detecting probe 12 can also be enfolded at a protrusion of the dental implant; the detecting probe 12 has a changeable size according to the dental implant or the metal attachment 11 and the detecting probe 12 has a detector changeable according to detection precision.

The transducer/detector driver unit 13 is connected with the detecting probe 12 at an end; and is connected with the detecting instrument 14 at another end through a cable line 21, where the transducer/detector driver unit 13 can also be connected with the detecting instrument 14 directly without the cable line 21.

The detecting instrument 14 comprises a liquid crystal display (LCD) 141 a sound-wave vibration producing device 142, a structural-response receiver and frequency analyzer unit 143, a processor 144, a memory 145 and a button control device 146. And the detecting instrument 14 is connected with a personal computer 15 through a universal serial bus (USB) cable 22. Therein, the detecting instrument 14 is built-in with a lithium battery rechargeable through a 110-volt socket or a USB jack; and displays a value of a resonance frequency, a capacity of the memory and a capacity of the battery. The sound-wave vibration producing device 142 produces a sound wave with a frequency between 1 kilo-Hertz (kHz) and 20 kHz. And, the personal computer 15 transmits detected data through the USB cable 22; and controls the detecting instrument 14 through a computer operation interface for detection. Thus, with the above structure, a novel apparatus of an irregular bone defect detection of a dental implant is obtained.

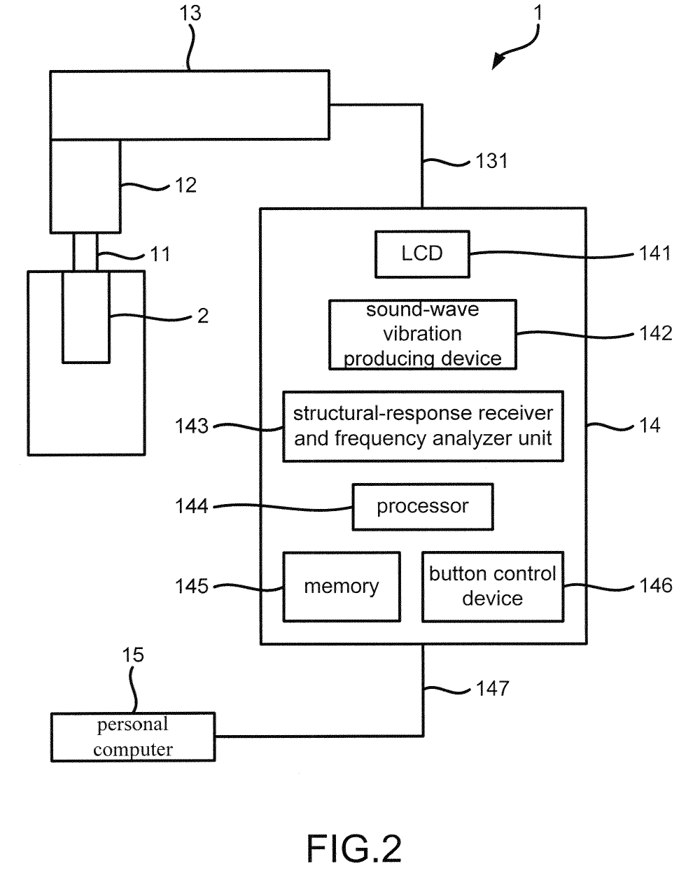

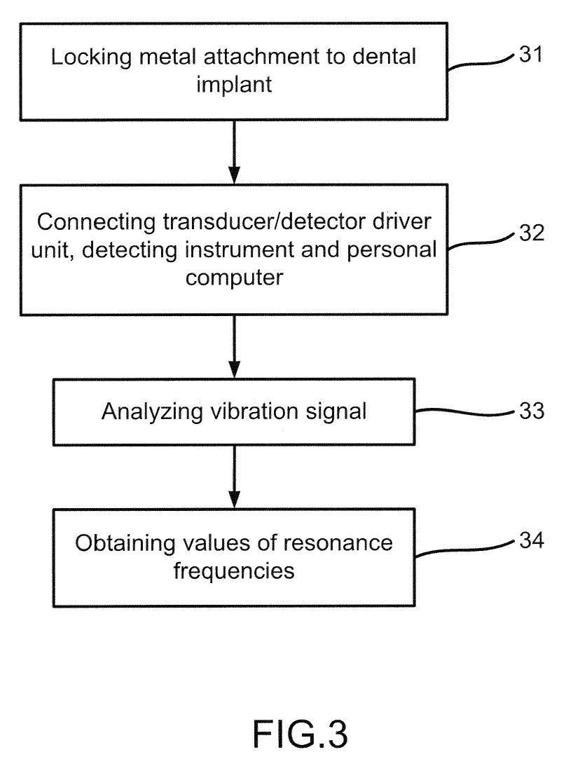

Please refer to FIG. 2 and FIG. 3, which are views showing a status of use and a detection flow. As shown in the figures, a method is used for detecting a dental implant 2 with an apparatus 1 according to the present invention, which comprises the following steps:

(a) Locking metal attachment to dental implant 31: A metal attachment 11 is locked on the dental implant 2. And, a detecting probe 12 and a transducer/detector driver unit 13 are connected together and are enfolded on the metal attachment 11. Therein, the detecting probe 12 can also be enfolded on a protrusion of the dental implant 2 directly.

(b) Connecting transducer/detector driver unit, detecting instrument and personal computer 32: The transducer/detector driver unit 13 is connected with a detecting instrument 14 through a cable line 131; and, the detecting instrument 14 is connected with a personal computer 15 through a USB cable 147. And, the personal computer 15 is used to control operations of the detecting instrument 14; and testee data are transferred to the personal computer 15 to be managed. Therein, the transducer/detector driver unit can also be connected with the detecting instrument 14 directly.

(c) Analyzing vibration signal 33: A sound wave is produced by a sound-wave vibration producing device 142 of the detecting instrument 14 with a sound transducer of the detecting probe 12 through the transducer/detector driver unit 13 to vibrate the metal attachment 11. A vibration signal is thus sensed and received through a micro accelerometer of the detecting probe 12. Then the vibration signals transmitted to a structural-response receiver and frequency analyzer unit 143 of the detecting instrument 14 through the transducer/detector driver unit 13 to be analyzed.

(d) Obtaining values of resonance frequencies 34: After the analysis, the vibration signals transformed to a digital signal to be transmitted to a processor 144 of the detecting instrument 14. Then values of resonance frequencies sensed by the micro accelerometer are figured out by the processor 144. Then the calculated data are displayed on an LCD 141 and are stored in a memory In step (d), a button control device 146 of the detecting instrument 14 transmits a control signal to the processor 144 for selection or adjustment through buttons, such as changing a frequency range of a sound wave, adding storage data, deleting storage data, or controlling a pair of a sound transducer and a micro accelerometer. Hence, a synchronous or direction-changing detection is processed as needed.

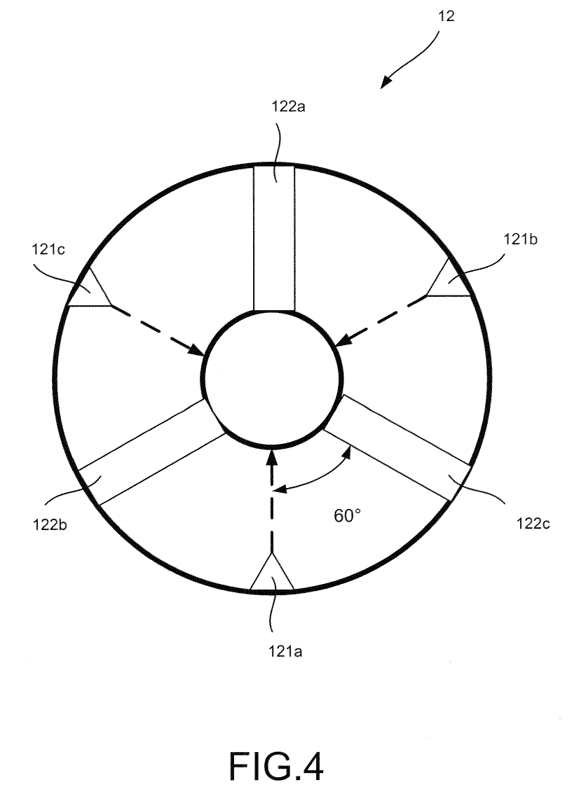

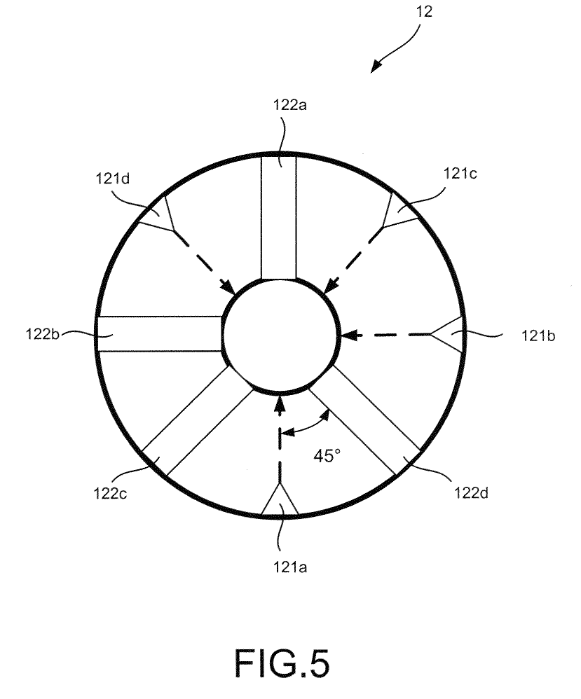

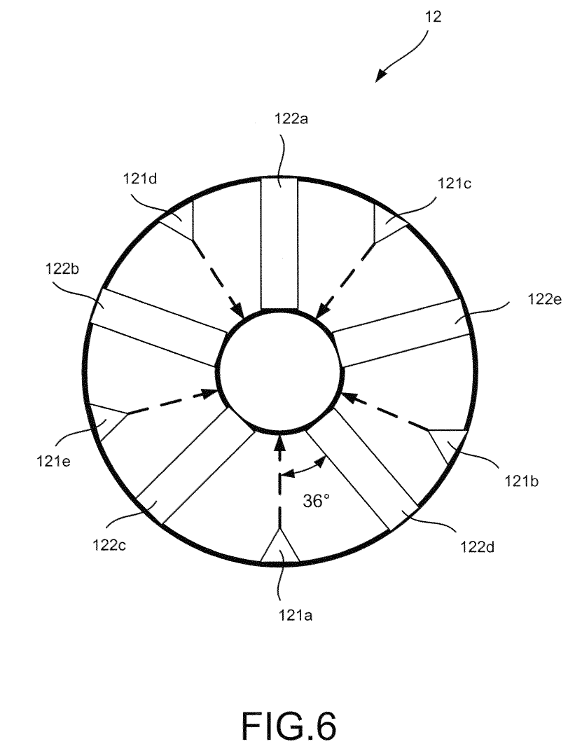

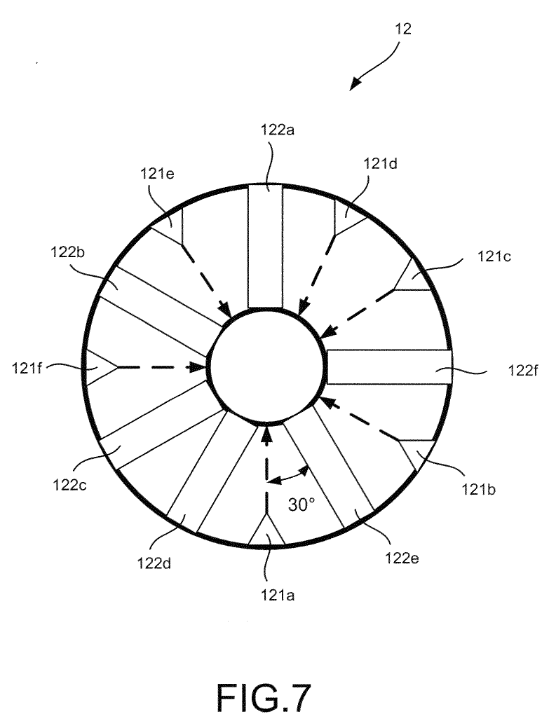

Please refer to FIG. 4 to FIG. 7, which are views showing a first to a seventh preferred embodiments of a detecting probe. As shown in the figures, on using the present invention, a first to a fourth preferred embodiments of a detecting probe 12 are designed to be used according to requirements. The detecting probes 12 includes a set of three pairs of a sound transducer and a micro accelerometer 121a,121b,121c/122a, 122b,122c with a separation of a 60-degree angle; a set of four pairs of the sound transducer and the micro accelerometer 121a,121b,121c,121d/122a,122b,122c,122d with a separation of a 45-degree angle; a set of five pairs of the sound transducer and the micro accelerometer 121a,121b,121c,121d, 121e/122a,122b,122c,122d,122e with a separation of a 36-degree angle; and a set of six pairs of the sound transducer and the micro accelerometer 121a,121b,121c,121d, 121e,121f/122a,122b,122c,122d,122e,1 22f with a separation of a 30-degree angle. The detecting probes 12 use a non-invasive detecting method, where a sound vibration is used and detecting probes are used to emit and receive vibration signals. Thus, values of resonance frequencies are detected to be summarized for obtaining a relationship between structural resonance frequencies and bone defects. Since frequency decreases as defect increases, quality, direction and depth of irregular bone defect are figured out with differences of structural resonance frequencies detected by the pairs of the sound transducer and the micro accelerometer at different angles. In addition, a firmness of an osseointegration is thus evaluated. Hence, the present invention is of great help to dental diagnosis and osseointegration surgery.

To sum up, the present invention is an apparatus and method of an irregular bone defect detection of a dental implant, where an osseointegration status between a dental implant and an alveolar bone is evaluated quantitatively and a quality, a direction and a depth of a bone defect are detected for ensuring strength of the dental implant.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An apparatus of an irregular bone defect detection of a dental implant, comprising:
a metal attachment, said metal attachment being locked on a dental implant;
a detecting probe, said detecting probe being enfolded on said metal attachment to output and receive vibration;
a transducer/detector driver unit, said transducer/detector driver unit connecting to said detecting probe; and
a detecting instrument, said detecting instrument connecting to said transducer/detector driver unit through a cable line at an end of said detecting instrument, said detecting instrument connecting to a personal computer through a universal-serial-bus (USB) cable at another end of said detecting instrument.

2. The apparatus according to claim 1,
wherein said metal attachment is made of an anticorrosive metal material.

3. The apparatus according to claim 1,
wherein said metal attachment has a thread at bottom;
wherein said metal attachment has a pillar shape; and
wherein said metal attachment has a size changeable according to said dental implant.

4. The apparatus according to claim 1,
wherein said detecting probe comprises a sound transducer at a transmitting end; and a micro accelerometer at a receiving end.

5. The apparatus according to claim 1
wherein said detecting probe is enfolded at a protrusion of said dental implant.

6. The apparatus according to claim 1,
wherein said detecting probe has a size changeable according to a component selected from a group consisting of said dental implant and said metal attachment; and
wherein said detecting probe has a detector changeable according to a detecting precision.

7. The apparatus according to claim 1,
wherein said detecting instrument comprises a liquid crystal display (LCD), a sound-wave vibration producing device a structural-response receiver and frequency analyzer unit, a processor, a memory and a button control device.

8. The apparatus according to claim 7,
wherein said LCD displays a value of a resonance frequency, a capacity of said memory and a capacity of a battery.

9. The apparatus according to claim 7, wherein said sound-wave vibration producing device produces a sound wave having a frequency between 1 kilo-Hertz (kHz) and 20 kHz.

10. The apparatus according to claim 7,
wherein said structural-response receiver and frequency analyzer unit receives a vibration signal detected by said micro accelerometer; and
wherein said structural-response receiver and frequency analyzer unit analyzes and transforms said vibration signal into a digital signal.

11. The apparatus according to claim 7,
wherein said button control device outputs a control signal to said processor; and
wherein said button control device uses buttons to operate an action selected from a group consisting of changing a frequency range of a sound wave, adding storage data, deleting storage data and controlling a pair of a sound transducer and a micro accelerometer.

12. The apparatus according to claim 11,
wherein said processor receives said control signal to obtain functions selected from a group consisting of selection and adjustment.

13. The apparatus according to claim 1,
wherein said detecting instrument is directly connected with said transducer/detector driver unit.

14. The apparatus according to claim 1
wherein said detecting instrument is built-in with a rechargeable lithium battery.

15. The apparatus according to claim 1,
wherein said apparatus has a method comprising steps of:
(a) locking said metal attachment on said dental implant and connecting said metal attachment to said detecting probe and said transducer/detector driver unit to be enfolded on said metal attachment;
(b) connecting said transducer/detector driver unit to said detecting instrument through a cable line and connecting said detecting instrument to a personal computer through said USB cable;
(c) producing a sound wave by said sound-wave vibration producing device of said detecting instrument with said sound transducer of said detecting probe through said transducer/detector driver unit to vibrate said metal attachment; receiving a vibration signal through said micro accelerometer; and transmitting said vibration signal to said structural-response receiver and frequency analyzer unit through said transducer/detector driver unit to be analyzed; and
d) transmitting analyzed data to said processor to be calculated to display values of resonance frequencies of micro accelerometers on said LCD and store said values of resonance frequencies in a memory.
